(19) United States
(12) Patent Application Publication
(10) Pub. No.: US 2010/0214338 A1
(43) Pub. Date: Aug. 26, 2010

(54) COMPENSATION FOR THERMAL DISTORTION IN A PRINTING SYSTEM

(75) Inventors: Michael Brookmire, Washougal, WA (US); Hsue-Yang Liu, Vancouver, WA (US); Weiyun Sun, Vancouver, WA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/393,345

(22) Filed: Feb. 26, 2009

(51) Int. Cl. B41J 29/38

(52) U.S. Cl. 347/14; 347/17

(57) ABSTRACT

A method of compensating for thermally induced misalignments in a printing system includes measuring two or more temperatures of a structure within the printing system, mathematically differencing the two or more temperatures to produce a differenced value, inputting the differenced value into a correlation equation, the correlation equation predicting a misalignment of a target printing system component, and compensating for the predicted misalignment of the target printing system component.

### BACKGROUND

High precision printing relies on precise placement of ink on a substrate surface to create images. During the printing process, heat is generated by a number of components and processes within the printer. This heat can cause thermal gradients which distort the structure of the printer and result in misalignments and inaccuracies in depositing the ink on the substrate.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a perspective view of an illustrative embodiment of a structure which supports printer components, according to one embodiment of principles described herein.

FIG. 2 is a side view of an illustrative printing system, according to one embodiment of principles described herein.

FIG. 3 is side view of an illustrative printing system, according to one embodiment of principles described herein.

FIGS. 4A and 4B are diagrams illustrating distortions caused by thermal gradients in structural components of a printing system, according to one embodiment of principles described herein.

FIG. 5 is an illustrative diagram showing placement of pens in an illustrative printing system, according to one embodiment of principles described herein.

FIG. 6 is a diagram showing illustrative locations for temperature sensors in a printing system, according to one embodiment of principles described herein.

FIG. 7 is an illustrative graph showing temperature measurements of a printing system, according to one embodiment of principles described herein.

FIG. 8 is an illustrative graph showing correlations between temperature differences and misalignments in dot placement as a function of time, according to one embodiment of principles described herein.

FIG. 9 is an illustrative graph showing a curve fit which can be used to correlate mathematically differenced temperatures to pen misalignments, according to one embodiment of principles described herein.

FIG. 10 is a flowchart which shows one illustrative method for compensating for thermal gradients in printing systems, according to one embodiment of principles described herein.

Throughout the drawings, identical reference numbers designate similar, but not necessarily identical, elements.

### DETAILED DESCRIPTION

High precision printing relies on precise placement of ink on a substrate surface to create images. During the printing process, heat is generated by a number of components and processes within the printer. This heat can cause thermal gradients which distort the structure of the printer and result in misalignments and inaccuracies in depositing the ink on the substrate.

For example, misplacements of ejected ink droplets by as little as 10 microns can cause print quality defects which are visible and unacceptable to users of the printing system. Common printing temperatures can distort the printing structure by as much as about 100 microns. Further, the printing misalignments are generally a non-linear function of temperature, which makes printing misalignments difficult to model and predict.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

According to one illustrative embodiment, an automatic, real-time alignment of printhead images compensates for thermally induced structural distortion in a printing system. A small number of strategically placed temperature sensors measure the temperatures of structural components of the printing system. Mathematical “differencing” of these temperatures can be used to accurately predict the misalignment of printheads due to thermal gradients in the structural components. The mathematical differencing approach can predict printhead misalignments in position and angle. In systems where multiple printheads are used, such as page-wide-array inkjet printers, this approach provides misalignment prediction for each of the printheads. In general, the mathematical differences used are not computationally intensive, yet provide very accurate results. The printhead misalignments can then be corrected by altering the firing timing or repositioning the printhead.

As used in the specification and appended claims, the term “differencing,” “difference formula” or “mathematical differencing” refers to mathematical formulas which accept as input two or more temperature readings. The mathematical formulas then output a value which relates to one or more thermal gradients which are present in the printing system. In some cases, the differencing formula may be selected based on its ability to accurately predict printhead or other misalignments over a range of temperatures and operating conditions. The terms “differencing,” “difference formula” or “mathematical differencing” are not limited to the subtraction of one value from another value, but may include a variety of other mathematical operations such as multiplication, scaling factors, addition, division, exponents, trigonometric function, logarithmic operations, matrix operations, and others.

As used in the specification and appended claims, the term “strategically placed” or “strategically placing” refers to selecting locations for temperature sensors on structural components such that the temperatures can be correlated to misalignments of the printheads. “Strategically placing” temperature sensors can be done by accounting for a number of factors including, but not limited to, identifying locations within the printer structure that support or influence the printheads, identifying locations that will accurately measure temperature gradients that cause deformation, selecting locations that have the highest or lowest local temperatures, and other factors.

According to one illustrative embodiment, four thermistors are strategically placed throughout the printing system. The mathematical differencing of temperature measurements made by the four thermistors produces a strong correlation with printhead misalignments. The firing timing of the printheads can be adjusted in real time to compensate for the predicted misalignments. Further, these compensations may be made when printing is not occurring to ensure that even if the printing system has been idle for long periods of time, the first printed page has the desired quality.

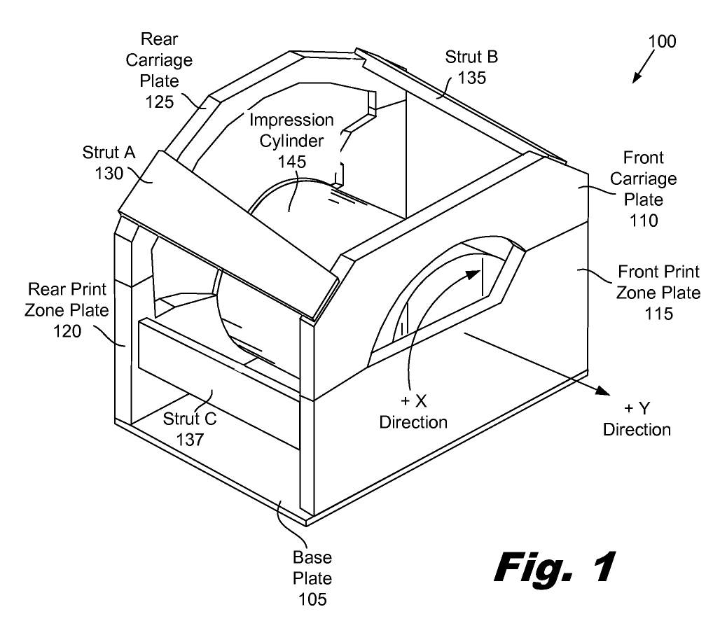

FIG. 1 is a diagram which shows an illustrative structure (100) which supports the internal components which make up a portion of a printing system. According to one illustrative embodiment, the structure (100) comprises a base plate (105), a front print zone plate (115), and a front carriage plate (110). The front print zone plate (115) is attached to the base plate (105) and supports the front carriage plate (110). A rear print zone plate (120) is also attached to the base plate (105) and supports a rear carriage plate (125). The front carriage plate (110) and the rear carriage plate (125) form arches which provide clearance and/or access to various internal components. The front and rear carriage plates (110, 125) are connected by several struts (130, 135, 137). These struts (130, 135, 137) tie the two sides of the printer structure together and may conduct thermal energy from one side of the printer structure to the other. There may be number of other components, struts, and structural details which are not included in the figures or description. This description is not intended to be exhaustive or to limit the principles discussed to any precise form disclosed. Many modifications and variations are possible.

According to one illustrative embodiment, the structural components may be formed from aluminum, such as plate aluminum or die cast aluminum. As can be seen in FIG. 1, the front print zone plate (115) and the front carriage plate (110) are generally thicker and more massive than the rear carriage plate (125) and the rear print zone plate (120). For example, the rear carriage plate (125) forms a much larger aperture between its lower edge and the upper portion of the rear print zone plate (120). As a consequence, the front plates (115,110) have a greater thermal mass and a greater ability to equalize thermal gradients than the rear plates (120,125).

The printing coordinate system is based on the outer surface of the impression cylinder (145). According to one illustrative embodiment, the impression cylinder (145) is supported by the structure (100) and spans its width. The impression cylinder (145) rotates clockwise as viewed from the front of the machine looking at the front carriage plate (110). The +X direction is the feed direction of the substrate and is tangent to the surface of the impression cylinder (145). The +Y direction is parallel to the axis of the impression cylinder as shown in FIG. 1.

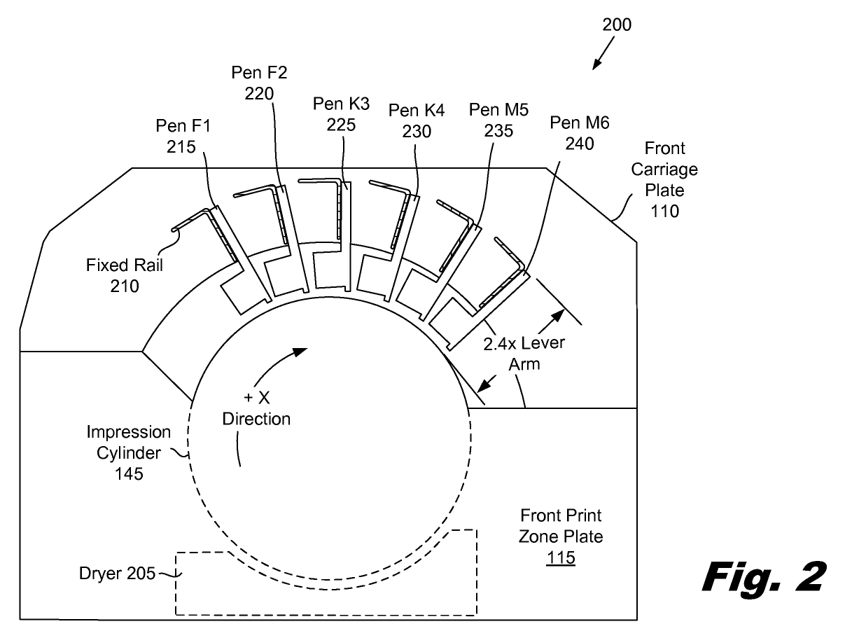

FIG. 2 is a cross-sectional diagram of an illustrative printing system (200) which shows various internal components which are supported by the structure (100, FIG. 1). The view of FIG. 2 is looking in the negative Y direction at the outside surfaces of the front plates (110). The substrate which is to be printed is fed onto an impression cylinder (145). The impression cylinder (145) is a rotating drum which spans the interior of the printing structure. The impression cylinder (145) grips the substrate using a variety of mechanisms, including, but not limited to, a gripper mechanism which secures the leading edge of the substrate and suction ports which pull the substrate firmly against the outer perimeter of the impression cylinder. The impression cylinder (145) rotates about its axis and moves the substrate past a number of pens (215-240). These pens (215-240) may incorporate a variety of technologies for dispensing ink or other solutions onto the substrate. In one embodiment, the pens (215-240) are arrays of thermal ink jet nozzles. Multiple pens may operate together to span the width of the substrate. For example, Pen K3 (225) may deposit ink on the left hand portion of the substrate and Pen K4 (230) may deposit the same color or colors of ink on the right hand portion of the substrate.

According to one illustrative embodiment, substrate is fed from the left and is captured by the impression cylinder (145) which is rotating counterclockwise. The substrate first encounters the fixer pens: Pen F1 (215) and Pen F2 (220). The fixer pens (215, 220) deposit an undercoat of fixer/crasher solution which improves the drying and stability of the subsequently deposited inks. The substrate and impression cylinder continue to rotate and encounter the black/yellow pens: Pen K3 (225) and Pen K4 (230). The black/yellow pens (225, 230) span the width of the substrate and deposit the black and yellow portions of the desired image, which may include pictures and text. For example, if the desired image is made up only of black text, the black/yellow pens (225, 230) deposit only the black ink required to form the text. However, if portions of the desired image include colors which are partially made up of the primary color yellow, the black/yellow pens (225, 230) will also deposit yellow ink in the appropriate locations.

The substrate next encounters the magenta/cyan pens: Pen M5 (235) and Pen M6 (240). Similar to the black/yellow pens, the magenta/cyan pens (235, 240) are arranged to span the width of the substrate and deposit magenta and cyan inks in the appropriate locations on the substrate to form the desired image. The substrate then rotates beneath the impression cylinder (145) and encounters the dryer (205). The dryer (205) produces convective and radiant heat which dries the ink and increases the permanence of the printed image. The printed substrate may continue to rotate with the impression cylinder (145) for multiple revolutions or may exit the impression cylinder (145) for duplexing, post processing, or collating.

The alignment of the pens (215-240) with each other and the impression cylinder (145) is critical to the correct placement of ink. As discussed above, the pens may use ink jet technology to deposit the ink. If a pen is misaligned with another pen and/or the impression cylinder, the ink droplets ejected from the pens will impact the substrate in the wrong locations. This can lead to undesirable print artifacts and loss of print quality. For example, misaligned pens can produce color variations, blurring, smear, and other undesirable artifacts.

The pens (215-240) are attached to fixed rails (210), which are connected between the front carriage plate (110) and the rear carriage plate (124). According to one illustrative embodiment, the pens can slide along the fixed rails (210) to adjust the pen location across the width of the substrate. The pens (215-240) are calibrated and adjusted as necessary to be aligned with the substrate/impression cylinder and with each other. Ideally, the pens would remain aligned and calibrated throughout the printer operation. However, due to thermal gradients in the structure (100), the plates and rails supporting the pens can become distorted. This distortion can cause changes in the location and orientation of the pens with respect to each other and the impression cylinder. Because of the cantilevered position of the pens (215-240), the distortion of the structure is amplified by a factor of about 2.4 times at the tip of the pen. As the pens become misaligned through thermal distortion of the structure, ink patterns are deposited by the pens in incorrect locations and produce artifacts which degrade the print quality.

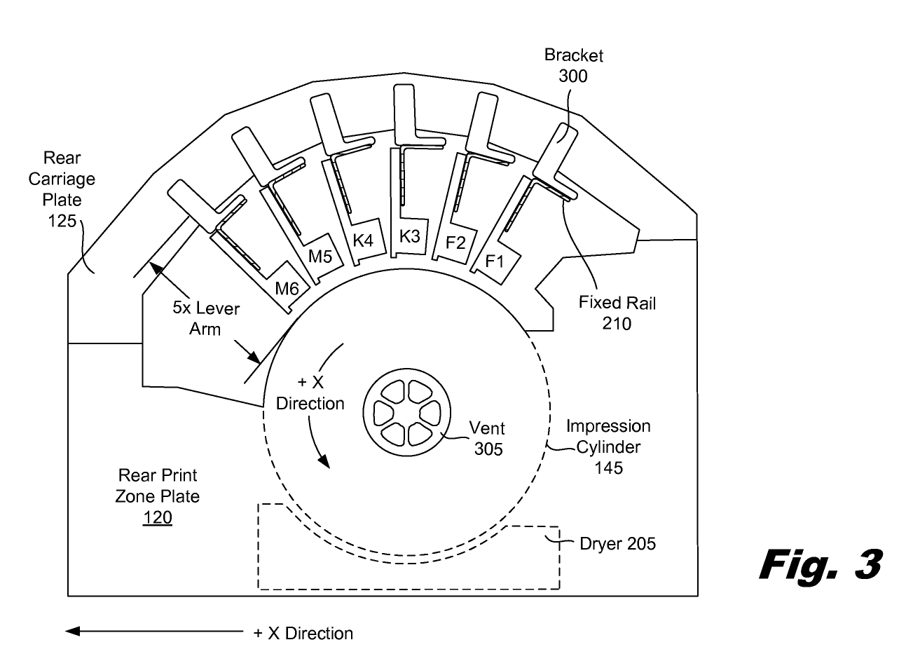

FIG. 3 shows a side view of the printing system, looking in the positive Y direction at the outer surface of the rear plates (120, 125). The rear carriage plate (125) forms an arch which is connected on either end to the rear print zone plate (120). This rear arch is higher and larger than the opening formed by the front plates (110, 115). Consequently, an additional bracket (300) is used to attach opposite end of the fixed rails (210) to the rear carriage plate (125). The pens (F1-M6) are connected to the fixed rails. This arrangement results in the pens (F1-M6) being cantilevered a significant distance below the rear carriage plate (125). As a result of this cantilevered configuration, distortions in the shape of the rear carriage plate (125) are magnified by approximately a factor of five at the tip of the pens (F1-M6).

During the printing process, a number of components generate a significant amount of heat. For example, electronics, motors, and print heads all generate heat. In particular, the dryer (205) may generate as much as 2000 watts of heat. This heat may be dissipated in a number ways, including convection, conduction, or radiation mechanisms. Additionally, the impression cylinder sucks air from the surroundings to create a vacuum which pulls the substrate against the impression cylinder. This air is exhausted out of a vent (305) on the rear print zone plate. The vacuum mechanism itself may generate significant heat as well as drawing air heated by the dryer into the impression cylinder (200) and out of the vent (305).

The combination of the vacuum mechanism, dryer (205), and other heat sources produce a large flux of heat which is introduced into the front and rear plates (110, 115, 120, 125). As heat enters a body, the body expands proportionally to its change in temperature. If a body with homogeneous material properties is uniformly heated, it expands photographically with minimal distortion. However, if a thermal gradient is present within the body, distortion occurs as one portion of the body expands while other portions of the body attempt to resist the expansion.

According to one illustrative embodiment, the rear plates (120, 125) may experience significantly more distortion than the front plates (110, 115). The rear plates (120, 125) may be exposed to a higher heat flux due to the exhaust vent (305). Additionally, the rear plates (120, 125) have thinner cross-sections through which heat can travel to other portions of the rear plates (120, 125). Further, the rear carriage plate (125) is much less rigid structure than the front carriage plate (110).

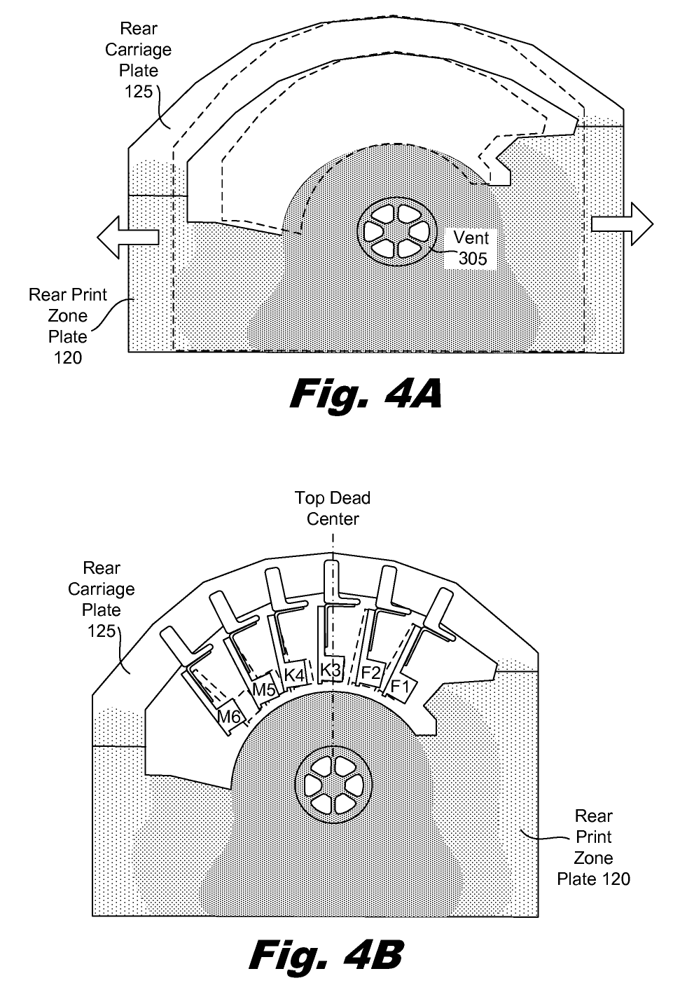

FIGS. 4A and 4B are figures which show an illustrative thermal gradient in the rear plates (120, 125). The darker areas illustrate areas of the plate with higher temperatures and the lighter areas illustrate lower temperatures. As illustrated in FIG. 4A, the higher temperature area is closer to the dryer (205) and vent (305) which force significant heat fluxes into the rear print zone plate (120). The heat is dispersed into the surrounding areas of the rear plates (120, 125) and is eventually transferred out of the rear plates and into the surrounding environment. Because the heat must travel through a relatively long and circuitous path to enter the center of the rear carriage plate (125), the rear carriage plate (125) remains at a significantly lower temperature than the central portions of the rear print zone plate (120). Consequently, a significant thermal gradient can be generated across the rear print zone plate (120) and the rear carriage plate (125) during the operation of the printing system.

The thermal gradient produces distortion in the rear plates which is also illustrated in FIG. 4A. A dotted profile represents the original geometry of the rear plates, while the solid outline represents the distorted rear plates. The displacements shown in FIG. 4A are greatly exaggerated for purposes of illustration. Actual distortions are only a very small fraction of the overall dimension of the plate and are generally imperceptible to the human eye. Further, the displacements illustrated are not intended to be quantitative or precise representations of the actual distortion in the system. Rather, FIG. 4A is intended to convey one illustrative embodiment to provide a better understanding of the method for compensating for thermal distortion within the printing system.

As shown in FIG. 4A, the rear print zone plate (120) is significantly hotter than the rear carriage plate (125). The horizontal dimension of the rear print zone plate (120) increases as a result of the thermally induced expansion of the aluminum. The rear carriage plate (125) does not have sufficient stiffness to withstand the expansion of the rear print zone plate (120) and has been stretched and flattened.

FIG. 4B shows the resulting misalignments of the pens. Again, the misalignment of the pens has been greatly exaggerated for purposes of illustration. As can be seen from FIG. 4B, the K3 pen is located near the top dead center of the device and, due to the symmetry of the structure, the K3 pen experiences very little distortion induced motion. However, the other pens experience significant misalignments as the angle and position of their attachment points to the rear carriage plate (125) change. The original/aligned positions of the pens are shown as dotted outlines. The misaligned positions of the pens are shown as solid outline superimposed over the dotted outlines. The misalignment tends to increase for pens that are farther away from the top dead center position. For example, the pen M6 is the farthest away from the top dead center position and can experience the greatest deformation.

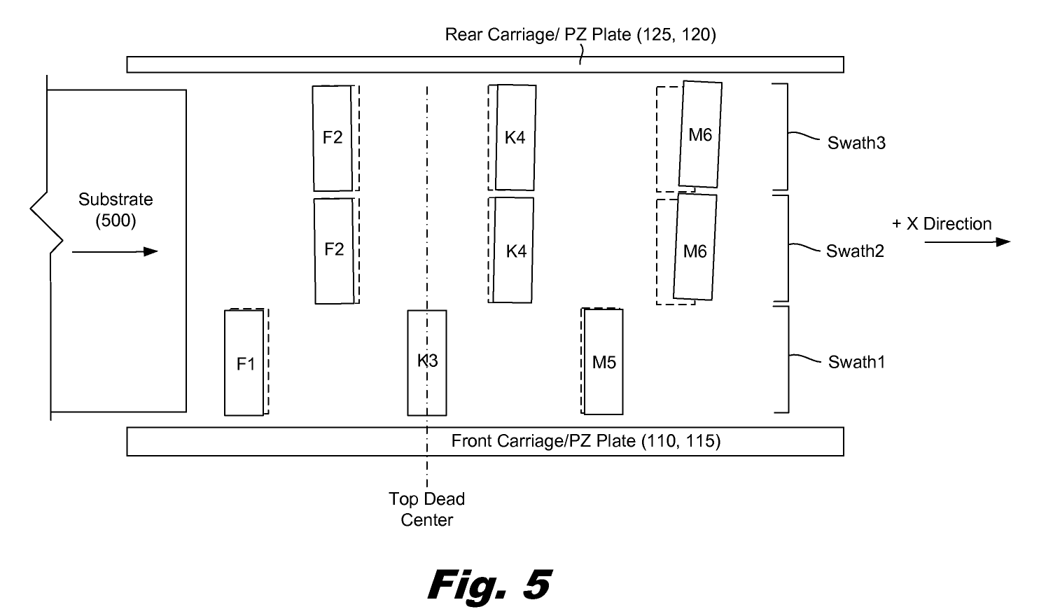

FIG. 5 is diagram of the pen layout flattened to form a planar diagram which shows the location of each of the pens and the front and rear plates. According to one illustrative embodiment, each of the pens is approximately four and a half inches in length. Consequently, two pens in tandem have a width which is sufficient to print an 8½ by 11 inch substrate. Three pens have a combined width of over 12 inches and can print a B size substrate.

The pen layout shown in FIG. 5 is divided into three swaths, where each swath has a fixer pen, a black/yellow pen, and a magenta/cyan pen. The first swath is comprised of pens F1, K3, and M5. The second and third swaths are made up of pens F2, K4, M6. Dotted outlines show the original and aligned position of the pens, while the misaligned positions of the pens are shown as solid outlines. As shown in FIG. 5, the misalignments can be both in position and angle of the pens. Further, the misalignment is time dependent. The pens are initially aligned, but as the printing process begins, a surge of heat enters the portions of the structure adjacent to the heat generating components. This causes rapid misalignment which increases as the printing continues. During longer printing runs, the structure begins to reach steady state equilibrium and the misalignments may slightly decrease. However, even in steady state conditions, the misalignments can be severe because of the thermal gradients and resulting distortion.

Ideally, these misalignments would be overcome without consuming excessive computation power or requiring extensive redesign of the printing system. The solution should result in robust real time compensation which does not restrict the functionality of the device. For example, a solution which requires the printing device to be brought to a steady state condition and remain there throughout the printing process would introduce excessive delay while the printer warmed up and would waste a significant amount of energy. Further, the correction process should not disrupt the flow of print jobs to run frequent calibrations to correct for time or load dependent misalignments.

If the misalignment can be accurately predicted, the timing of the inkjet firing can be adjusted to compensate for the misalignment. Assuming that the misalignments illustrated in FIG. 5 are accurately known or predicted, the timing of the various pens can be adjusted to produce the desired level of alignment. The substrate (500) enters the printer from the left and moves in the positive X direction through the printer. The pens F1 and F2 are misaligned to the left. The firing timing on these pens can be advanced to deposit the ink on the desired locations of the substrate (500). To the right of top dead center, the pens K4, M5, and M6 are shifted to the right and firing timing on these pens can be delayed to deposit the ink on the desired locations. As can be seen from the illustrated misalignments, the misalignments may vary from pen to pen. For example, the M6 pens are much farther out of alignment than the M5 pen. Consequently, separate alignments can be performed for each pen. Further, the M6 pens show significant angular misalignment. The firing timing of individual nozzles within the pens can be altered to compensate for this angular misalignment. The K3 pen is at top dead center and generally remains aligned because of the symmetry of the physical structure. Consequently, the K3 pen can be used as reference against which all other pens can be aligned.

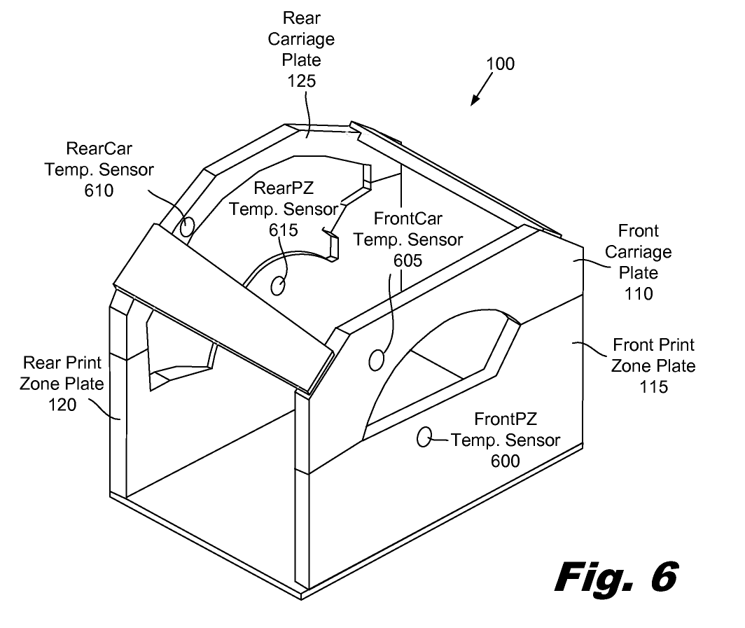

FIG. 6 shows four illustrative temperature sensors positioned on the structure (100). These temperature sensors may be any one of a variety of temperature sensors, including but not limited to, thermistors, platinum resistance thermometers, thermocouples, etc. These temperature sensors are thermally connected to the structure and provide real time measurements of the temperature of various portions of the structure. According to one illustrative embodiment, a FrontPZ temperature sensor (600) is located on the front print zone plate (115). A FrontCar temperature sensor (605) is located on an upper portion of the front carriage plate (110). Similarly, on the rear plates (120,125), a RearPZ temperature sensor (615) is located on the rear print zone plate (120) and a RearCar temperature sensor (610) is located on an upper portion of the rear carriage plate (125).

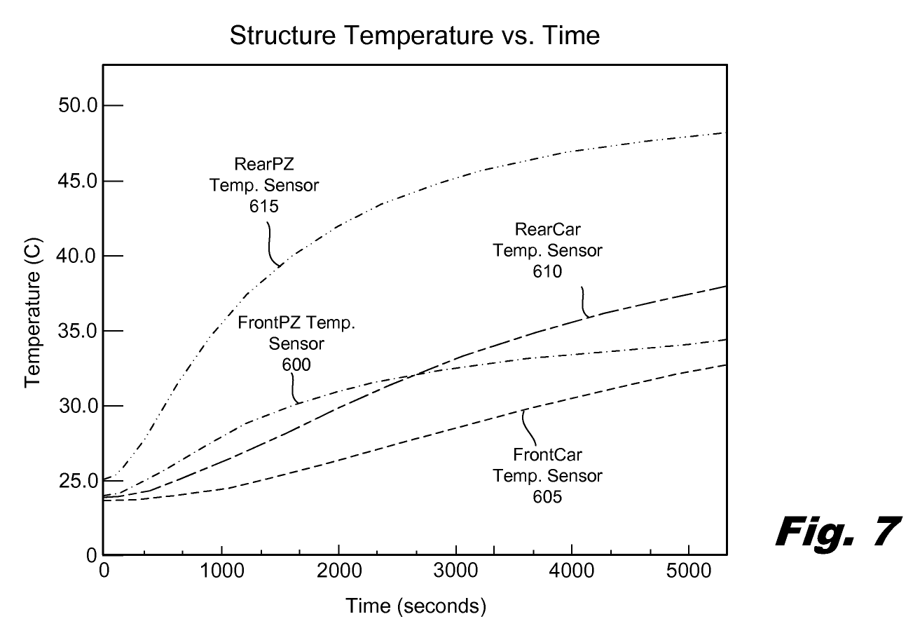

FIG. 7 is an illustrative graph of the structural temperatures sensed by the four temperature sensors (600, 605, 610, 615) as a function of time. The vertical axis of the graph shows temperatures in degrees Celsius, with lower temperatures at the bottom of the graph and progressively higher temperatures toward the top of the graph. The horizontal axis of the graph shows time in seconds, starting at zero seconds and ending about 5000 seconds. At time zero, the printing process began and the recording of temperatures sensed by the four temperature sensors began. As can be seen from the graph, the RearPZ temperature sensor (615) is represented as a dash-dot-dot line which rises rapidly from an initial temperature of 25 C and approaches 47 C as time continues. This rapid rise could be a result of a number of factors including the high heat flux into the rear print zone plate (120), the relatively small thermal mass of the rear print zone plate (120), and the small cross section available to carry heat away from the rear print zone plate (120). The RearCar temperature sensor (610) has much lower temperatures throughout the test. This indicates that there is a large thermal gradient in the rear plates (120, 125) and that the rear plates (120, 125) are very sensitive to thermal fluxes generated by the operation of the printing system. It can be seen from FIG. 7 that the temperature gradient in the rear plates (120, 125) very rapidly reacts to the operation of the printing system and can produce large pen misalignments soon after printing begins. Further, the temperatures and misalignment can change quickly when the printing is started or stopped.

The FrontPZ temperature sensor (600) and the FrontCar temperature sensor (605) rise much more slowly and have significantly less difference between the two sensors. This indicates that the Front plates have a far smaller thermal gradient than the rear plate and are much less thermally sensitive.

However, the temperature readings themselves do not correlate well with observed misalignments of the pens. Consequently the raw temperature readings may not be suitable as inputs for predicting misalignments. Rather, it was discovered that by differencing two or more temperature measurements, a strong correlation emerged which could provide the basis of predicting pen misalignments.

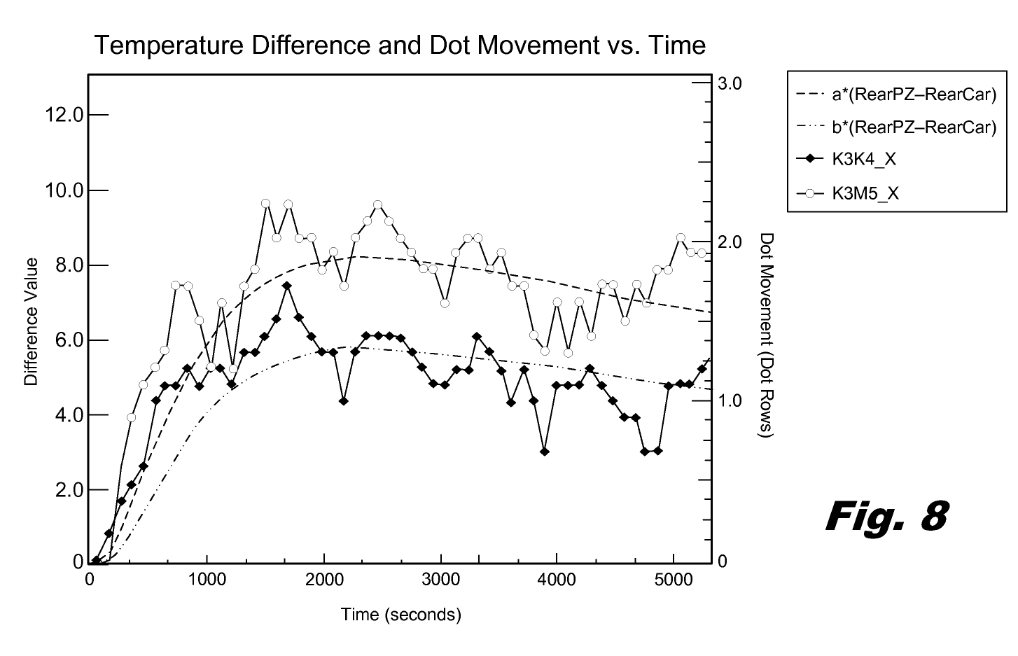

FIG. 8 shows a graph of scaled temperature differences which were discovered to have strong correlations with observed misalignments of the pens. The graph has dual vertical scales. The scale on the left shows difference values produced by a differencing formula, with low difference values shown on the bottom of the graph and progressively higher difference values being shown on the upper portions of the graph. The vertical scale on the right shows the measured dot misalignment on substrate measured in dot row. The term “dot rows” refers to the printing resolution in the feed direction of the substrate. The dot rows are lines of deposited ink which span the width of the substrate. For example, if the printing resolution is 1200 dots per inch in the feed direction, there would be 1200 dot rows per inch. The horizontal axis of the graph shows time in seconds.

The dashed curve represents the difference between the RearPZ temperature sensor reading and the RearCar temperature sensor reading multiplied by a scaling constant a. Similarly, the dash-dot-dot curve represents the difference between the RearPZ temperature sensor reading and the RearCar temperature sensor reading multiplied by a scaling constant b. Superimposed on the difference curves are dot misalignment measurements for pen K4 (data points are shown as black diamonds) and pen M5 (data points are shown as open circles). The measurements of misalignment are made using pen K3 as a reference. As discussed above, pen K3 is located near the top dead center of the structure and exhibits very little temperature induced misalignment. Consequently, pen K3 can serve as a reference against which the other pens alignments can be measured.

As can be seen in FIG. 8, the pen misalignments of pen K4 and pen M5 can are strongly correlated with the scaled temperature differences. The mathematical difference between RearPZ sensor and the RearCar sensor captures a fundamental measurement of the thermal gradient and resulting distortion in the rear plates. The scaling factors a and b can partially compensate for geometric variation between the pens. For example, for pen M6 a larger scaling factor could be used because of the generally larger misalignment of pen M6. A smaller scaling factor could be used for pens which are closer to the top dead center location such as pen F2 and pen K4.

Other more complex differences of the temperature readings could be used to create stronger correlations or pin point specific misalignments within the pens. For example, to create a difference that strongly correlates to the angular misalignment, one or more temperature measurements on the front plate could be differenced with one or more temperature measurements from the back plate to give an indication of the difference in expansion of which results in an angular rotation of the fixed rails and attached pens. The differences need not be simple differences but could be a variety of mathematical combinations such as linear, polynomial, logarithmic, interpolation, regression, extrapolation, or other mathematical operations.

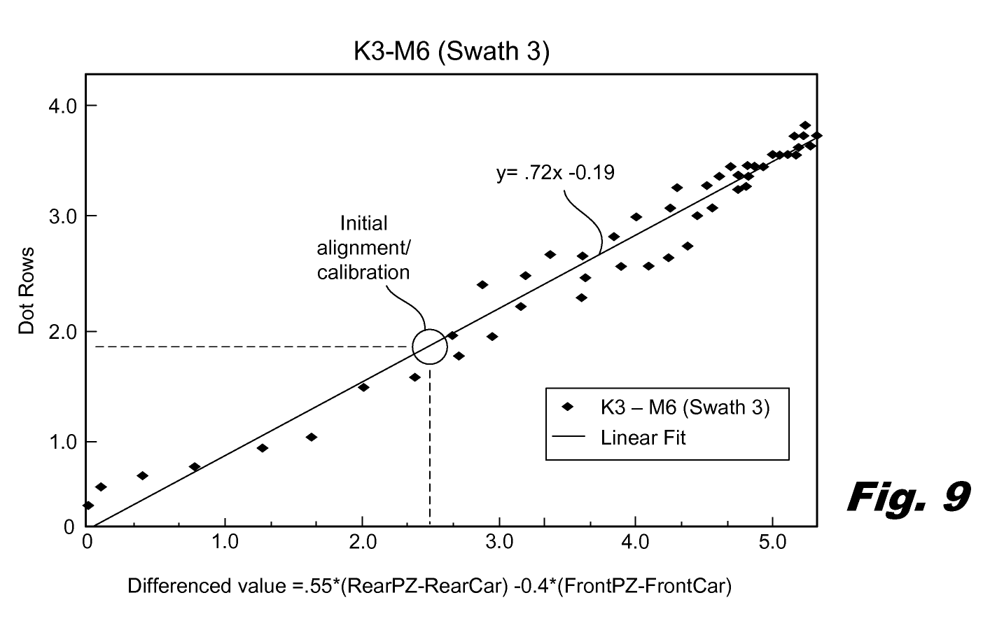

FIG. 9 is an illustrative graph which shows a more complex difference scheme which linearizes the relationship between the temperature difference and misalignment. This difference demonstrates an even stronger correlation between the differenced values and the misalignment of a pen M6. The vertical axis of the graph shows misalignment in “dot rows”.

The horizontal axis shows differenced values which were calculated using the differencing formula:

0.55(RearPZ−RearCar)−0.4(FrontPZ−FrontCar) Eq. 1

The result of this difference is that the observed misalignments generally extend through a linear region which starts near the origin of the graph and extends into the upper right hand portion of the graph. This distribution of misalignments can be closely approximated using a linear curve fit. For example, the linear curve fit in this illustrative example is Y=0.72x-19. The “x” term is the input to the equation and indicates that the differenced value is input into the equation. The resulting “y” is the output of the equation and indicates how many dot rows of misalignment the M6 pen is predicted to be experiencing. In the illustrated example, the curve fit equation provides prediction accuracy of R=0.9703, where R is the correlation coefficient between the observe data and the curve fit.

According to one illustrative example, initial alignment of the pen can be chosen at an intermediate location in the range of measured or predicted misalignments. A solid circle indicates an intermediate location where an initial alignment could be made. For example, the pen M6 may be initially aligned in the middle of the range so that only moderate amounts of compensation are required to cover the complete range. At start up temperatures, the distortion may be minimal and the firing timing may have to be delayed to accurately place the ink droplets. As the distortion increases, less and less delay is required. At about 2.5 difference units, the pen reaches the initial calibration and no delay is required. As the temperature units continue to increase, the firing timing is then advanced to compensate for the increasing misalignment of the pen.

The relatively simple difference equation, linear relationship, and accuracy of the curve fit can make this approach very easy to implement in either hardware or software configurations. For example, if this thermal relationship is stable over time and between machines, a hardware circuit could be configured to make the difference calculation of sensed temperatures and apply the fit to predict the misalignment. This could be performed without requiring the use of a processor or memory. However, in most printing systems memory and processor time is available and the differencing functionality can be incorporated into software which already runs on the processor. For simple difference relationships, the burden on the processor and memory can be very minimal. Additionally, if the printing system is significantly altered, such as making an upgrade of the printing engine, replacement or repositioning of the pens, etc, the software can be upgraded to with a new differencing algorithm which accommodates the changes.

This compensation for pen misalignment can be performed in real time without requiring the printing process to be stopped. The direct predictive nature of the difference and correlation equations allows for pen misalignments to be calculated with only temperature measurements. The firing timing of the individual pens can then be delayed or advanced to compensate for the misalignment. Additionally, the firing timing of the individual inkjet nozzles within a pen can be delayed or advanced to compensate for angular misalignment of the pen. These adjustments to firing timing can be made in real time, perhaps as often as every printed page. By making real time adjustments to compensate for the misalignment of the pens, the printing system can be ready to print at any time and will not require a length warm up period.

Changing firing timing is only one illustrative method for compensating for pen misalignments. Other techniques could be used such as active physical realignment pens. A variety of actuators could be used to align the pens such as piezo electric actuation, motors, strategically placed heaters or other embodiments.

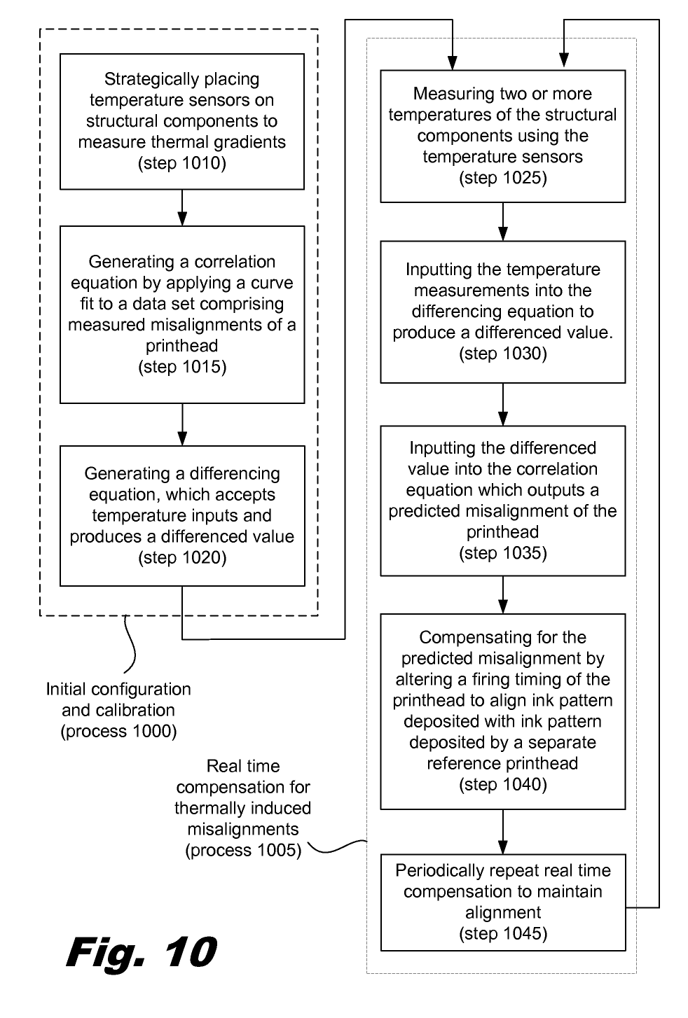

FIG. 10 is an illustrative method for compensating for thermal distortion in printing systems. The method includes an initial configuration and calibration (process 1000) and real time compensation for thermally induced misalignments (process 1005). The initial configuration and calibration (process 1000) includes strategically placing temperature sensors on structural components to measure thermal gradients (step 1010). In a second step, a correlation equation is generated by applying a curve fit to a data set made up of measured misalignments of a printhead (step 1015). A differencing equation is also generated, which accepts temperature inputs and produces a differenced value (step 1020). Additional steps may also be included in the initial configuration and calibration process, including but not limited to performing an initial alignment of the pens in the center portion of the predicted or measured range of misalignments.

After the initial configuration is performed, real time compensation for thermally induced misalignments (process 1005). First, two or more temperatures of the structural components are measured using the temperature sensors. These temperature measurements are then input into the differencing equation to produce a differenced value (step 1030). The differenced value is then input into the correlation equation which outputs a predicted misalignment of the printhead (step 1035). According to one illustrative embodiment, the differencing equation and correlation equation may be mathematically combined into a mapping equation. The mapping equation accepts temperatures as inputs and outputs the predicted misalignment of a pen.

The firing timing of the printhead is then altered to compensate for the predicted misalignment such that the ink pattern deposited by the printhead is aligned with an ink pattern deposited by a separate reference printhead (step 1040). This process is periodically repeated to maintain the desired level of alignment (step 1045).

In sum, the system and method for compensating for thermal distortion in a printing system leverages existing hardware and software to produce a practical, low-cost solution, to the complex problem of printhead misalignment. The strategic placement of temperature sensors on structural components measures temperatures which can be mathematically differenced to produce a very accurate correlation to the thermally induced misalignment. The accurate prediction of printhead misalignments allows for real time compensation and allows users the freedom to print at any time or temperature.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of compensating for thermally induced misalignments in a printing system comprising:
measuring two or more temperatures of a structure within said printing system;
mathematically differencing said two or more temperatures to produce a differenced value;
inputting said differenced value into a correlation equation, said correlation equation predicting a misalignment of a target printing system component; and
compensating for said predicted misalignment of said target printing system component.

2. The method of claim 1, further comprising strategically placing temperature sensors on said structure to measure thermal gradients in said printing system; said structure supporting said target printing system component.

3. The method of claim 1, further comprising compensating for predicted misalignment of said target printing system component in real time.

4. The method of claim 1, further comprising generating a difference equation, said difference equation comprising at least one subtraction operation and at least one scaling factor, said difference equation accepting said two or more temperatures and generating said differenced value.

5. The method of claim 1, further comprising generating a correlation equation by applying a curve fit to a data set comprising measured misalignments of said target printing system component.

6. The method of claim 1, further comprising initially calibrating said target printing system component to a position which is in a center portion of a measured range of misalignments.

7. The method of claim 1, further comprising making real time compensation for said predicted misalignment of said target printing system component.

8. The method of claim 1, wherein said target printing system component is a printhead.

9. The method of claim 8, further comprising compensating for said predicted misalignment of said printhead by altering a firing timing of said printhead.

10. The method of claim 8, further comprising measuring said misalignment of a said printhead with respect to a separate reference printhead, such that said compensation for said predicted alignment brings said printhead into more precise alignment with said reference printhead.

11. A method of compensating for thermally induced misalignments in a page-wide-array inkjet printing system comprising:
strategically placing temperature sensors on a structure within said printing system to measure thermal gradients in said printing system, said structure supporting a printhead;
generating a differencing equation, said differencing equation configured to operating on temperature inputs to produce a differenced value;
generating a correlation equation by applying a curve fit to a data set comprising measured misalignments of said printhead;
measuring two or more temperatures of said structure using said temperature sensors;
inputting said two or more temperatures to said differencing equation to produce a differenced value;
inputting said differenced value into said correlation equation, said correlation equation outputting a predicted misalignment of said printhead based on said differenced value; and
compensating for said predicted misalignment of said printhead by altering a firing timing of said printhead to align ink deposited by said printhead with ink deposited by a separate reference printhead.

12. The method of claim 11, further comprising:
predicting both location and angular misalignments of said printhead;
compensating for said location misalignment by adjusting an global firing parameter, said global firing parameter equally affecting nozzles within said printhead; and
compensating for said angular misalignments by adjusting individual firing timings of a plurality of nozzles within said printhead.

13. The method of claim 12, wherein a second differencing equation and a second correlation equation are generated to predict angular misalignments of said pen.

14. The method of claim 11, further comprising combining said differencing equation and said correlation equation to produce a mapping equation, said mapping equation receiving temperatures as inputs and outputting said predicted misalignment.

15. The method of claim 11, further comprising compensating for said predicted misalignment of said printhead in real time.
